(19) United States
(12) Patent Application Publication
(10) Pub. No.: US 2025/0314346 A1
(43) Pub. Date: Oct. 9, 2025

(54) UNIVERSAL APPARATUS FOR RIG CONSTRUCTION IN AUDIO-VISUAL APPLICATIONS

(71) Applicant: Matthews Studio Equipment, Inc., Burbank, CA (US)

(72) Inventors: Aaron Hammel, Burbank, CA (US); Tyler Phillips, IV, Burbank, CA (US)

(21) Appl. No.: 18/920,794

(22) Filed: Oct. 18, 2024

Related U.S. Application Data
(60) Provisional application No. 63/544,760, filed on Oct. 18, 2023.

(51) Int. Cl. F16M 11/18; F16M 11/04

(52) U.S. Cl. CPC F16M 11/18; F16M 11/04

(57) ABSTRACT

A universal apparatus for rig construction includes a main tube with an orifice through its length, the main tube further has one or more securing holes at its proximal end. The apparatus further includes tubular riser top and orifice running the length of the riser top. The riser top further includes one or more securing holes at its distal end. The apparatus further includes an insert rail configured to fit and secured at one end in the main tube orifice and further configured to be securable between a fully extended position and a fully retracted position in the main tube orifice. The insert rail is further configured to fit and be secured at the opposite end in the riser top orifice. The main tube, riser top, and insert rail are configured such that multiple combinations may be employed to achieve a desired length for a specific audio-visual application.

### CROSS-REFERENCE TO RELATED APPLICATIONS

The present application claims the benefit of U.S. Provisional Application Ser. No. 63/544,760, filed on Oct. 18, 2023, specification of which is herein incorporated by reference for completeness of disclosure

### BACKGROUND OF THE INVENTION

Setting up rigs for audio-visual applications in remote locations generally requires cutting and wasting of various metal tubes of different lengths and diameters in other to setup an appropriate rig for lights or other image capture equipment and support gear.

Traditional rigging often resembles a pipe organ-a mix of varying lengths of pipes essential for different lighting and camera setups. Crews are usually tethered to their grip or electric trucks, relying on a stockpile of pre-cut pipes or, even and more time-consuming, cutting pipes to fit specific needs, e.g. to mount grip heads for a specific audio-visual application.

Grip heads are well known components in the art used in setting up different types of lighting for a film set or photo studio. Thus, grip heads facilitate carrying out a wide range of lighting and other functions in the audio-visual industry.

A grip head is a versatile component configured to sit on top of light stands, C stands, or they attach to rigging clamps. They facilitate connecting lighting equipment, such as lights, flags, nets, props, and accessories, via various sized pins and rods, e.g. ⅝-inch and ⅜-inch rods.

To setup these grip heads for a specific task generally requires building of a unique rig (or structural frame) for the grip head. Because there are many different types of grip heads to consider, each specific audio-visual application requires specialized mounting components that would have to be designed and fabricated at considerable expense to the user.

To overcome the problems and limitations described above there is a need for a cost-effective universal metal fitting apparatus that eliminates the cutting, wasting, and the back-and-forth to the truck and provides the flexibility to instantly adapt the length right on set, ensuring a perfect fit every time and could easily be adjusted to fit the construction need of any rig for most audio-visual applications.

### SUMMARY OF THE INVENTION

One or more embodiments of the invention is directed to a universal apparatus for rig construction in audio-visual applications. Embodiments of the present invention provide a cost-effective universal metal fitting apparatus that eliminates the need for cutting, wasting, and the back-and-forth to the truck that is standard in rig construction for audio-visual applications and provides the flexibility to instantly adapt the length right on set, ensuring a perfect fit every time and is easily adjustable to fit the construction need of any rig for most audio-visual applications.

In one or more embodiments, the universal apparatus for rig construction comprises a main tube with an orifice running the length of the main tube. The main tube further comprises one or more securing holes at its proximal end. The securing holes may be threaded, for example.

In one or more embodiments, the universal apparatus for rig construction further comprises a riser top with an orifice running the length of the riser top. The riser top further comprises one or more securing holes at its distal end. The securing holes may be threaded, for example.

In one or more embodiments, the universal apparatus for rig construction further comprises an insert rail configured to fit inside the main tube orifice and further configured to be securable between a fully extended position and a fully retracted position in the main tube orifice using the one or more securing holes at the proximal end of the main tube. The insert rail is further configured to fit inside the orifice in the riser top and to be securable to riser top using the one or more securing holes at the distal end of the riser top.

In one or more embodiments, the universal apparatus for rig construction further comprises an optional sleeve couplable around the insert rail, between the main tube and the riser top.

In one or more embodiments, riser top of the universal apparatus for rig construction is configured for securing an audio-visual device, e.g. pin, grip head, rigging clamp, etc.

### BRIEF DESCRIPTION OF DRAWINGS

The above and other aspects, features and advantages of the invention will be more apparent from the following more particular description thereof, presented in conjunction with the following drawings wherein:

FIG. 1 is a perspective view of a universal apparatus for rig construction in audio-visual applications in accordance with one or more embodiments of the present invention.

FIG. 2 is an exploded view of the universal apparatus for rig construction in audio-visual applications in accordance with one or more embodiments of the present invention.

FIG. 3 is a side view illustration of the universal apparatus for rig construction in audio-visual applications in a closed position in accordance with one or more embodiments of the present invention.

FIG. 4 is an illustration of the universal apparatus for rig construction in audio-visual applications in an extended position with the optional sleeve in accordance with one or more embodiments of the present invention.

FIG. 5A is an illustration of the optional sleeve of the universal apparatus for rig construction in audio-visual applications in accordance with one or more embodiments of the present invention.

FIG. 5B is an illustration of one side of the optional sleeve of the universal apparatus for rig construction in audio-visual applications in accordance with one or more embodiments of the present invention.

FIG. 6 an illustration of an application of securing a rigging clamp to the top of the universal apparatus for rig construction in audio-visual applications in accordance with one or more embodiments of the present invention.

FIG. 7 is an illustration of the universal apparatus for rig construction in audio-visual applications in the closed position and with a rig pin thereon in accordance with one or more embodiments of the present invention.

### DETAILED DESCRIPTION OF THE INVENTION

The present invention comprising a universal apparatus for rig construction in audio-visual applications will now be described. In the following exemplary description numerous specific details are set forth in order to provide a more thorough understanding of embodiments of the invention. It will be apparent, however, to an artisan of ordinary skill that the present invention may be practiced without incorporating all aspects of the specific details described herein. Furthermore, although steps or processes are set forth in an exemplary order to provide an understanding of one or more systems and methods, the exemplary order is not meant to be limiting. One of ordinary skill in the art would recognize that the steps or processes may be performed in a different order, and that one or more steps or processes may be performed simultaneously or in multiple process flows without departing from the spirit or the scope of the invention. In other instances, specific features, quantities, or measurements well known to those of ordinary skill in the art have not been described in detail so as not to obscure the invention. It should be noted that although examples of the invention are set forth herein, the claims, and the full scope of any equivalents, are what define the metes and bounds of the invention.

For a better understanding of the disclosed embodiment, its operating advantages, and the specified object attained by its uses, reference should be made to the accompanying drawings and descriptive matter in which there are illustrated exemplary disclosed embodiments. The disclosed embodiments are not intended to be limited to the specific forms set forth herein. It is understood that various omissions and substitutions of equivalents are contemplated as circumstances may suggest or render expedient, but these are intended to cover the application or implementation.

The term “first”, “second” and the like, herein do not denote any order, quantity or importance, but rather are used to distinguish one element from another, and the terms “a” and “an” herein do not denote a limitation of quantity, but rather denote the presence of at least one of the referenced item.

Spatially relative terms, such as “beneath,” “below,” “lower,” “under,” “above,” “upper,” and the like, may be used herein for ease of explanation to describe one element or feature's relationship to another element(s) or feature(s) as illustrated in the figures. It will be understood that the spatially relative terms are intended to encompass different orientations of the device in use or in operation, in addition to the orientation depicted in the figures. For example, if the device in the figures is turned over, elements described as “below” or “beneath” or “under” other elements or features would then be oriented “above” the other elements or features. Thus, the example terms “below” and “under” can encompass both an orientation of above and below. The device may be otherwise oriented (e.g., rotated 90 degrees or at other orientations) and the spatially relative descriptors used herein should be interpreted accordingly.

It will be understood that when an element or layer is referred to as being “on,” “connected to,” or “coupled to” another element or layer, it can be directly on, connected to, or coupled to the other element or layer, or one or more intervening elements or layers may be present. In addition, it will also be understood that when an element or layer is referred to as being “between” two elements or layers, it can be the only element or layer between the two elements or layers, or one or more intervening elements or layers may also be present.

As used herein, the term “substantially,” “about,” and similar terms are used as terms of approximation and not as terms of degree, and are intended to account for the inherent deviations in measured or calculated values that would be recognized by those of ordinary skill in the art. Further, the use of “may” when describing embodiments of the present invention refers to “one or more embodiments of the present invention.” As used herein, the terms “use,” “using,” and “used” may be considered synonymous with the terms “utilize,” “utilizing,” and “utilized,” respectively. Also, the term “exemplary” is intended to refer to an example or illustration.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to”, “at least”, “greater than”, “less than”, and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth. The phrases “and ranges in between” can include ranges that fall in between the numerical value listed. For example, “1, 2, 3, 10, and ranges in between” can include 1-1, 1-3, 2-10, etc. Similarly, “1, 5, 10, 25, 50, 70, 95, or ranges including and or spanning the aforementioned values” can include 1, 5, 10, 1-5, 1-10, 10-25, 10-95, 1-70, etc.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

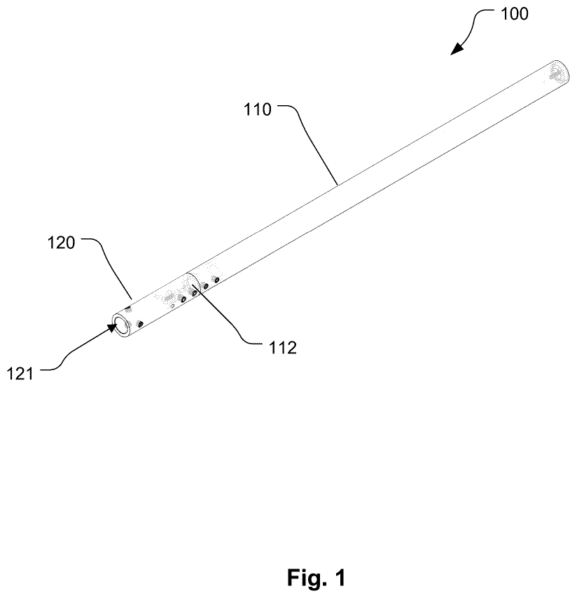

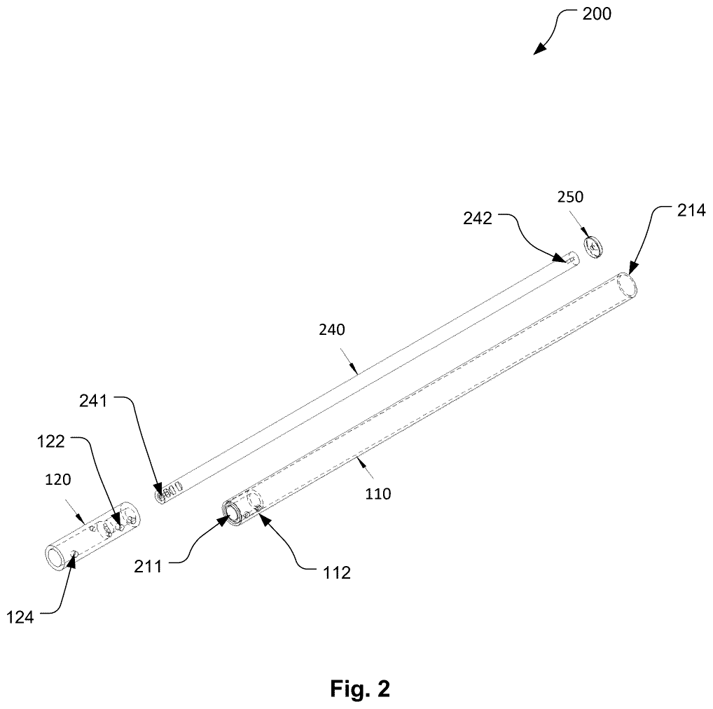

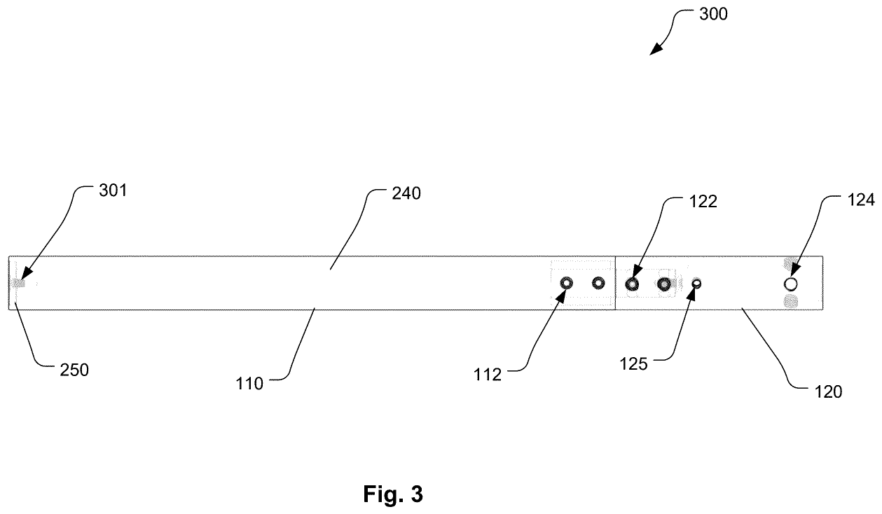

One or more embodiments of the present invention will now be described with references to FIGS. 1-7.

As illustrated in FIGS. 1-3, one or more embodiments of the universal apparatus 100 for rig construction in audio-visual and other applications comprises a main tube 110; riser top 120; insert rail 240; and cap 250. In one or more embodiments, insert rail 240 fits in an orifice 211 of the main tube 110, and cap 250 is secured to the distal end of insert rail 240 inside the main tube at distal end 214 using a bolt 301, for example.

In one or more embodiments, main tube 110 further comprises one or more holes (or apertures) 112 on the sidewall for securing the insert rail 240 in a fixed extended or retracted position to the main tube 110. This allows the user to be able to quickly adjust device 100 to a desired length for the specific audio-visual rigging application. Those of skill in the art would appreciate that the main tube could be configured with a cross-section such as a square, rectangle, triangle, rhombus, round, pentagon, hexagonal, etc.

In one or more embodiments, the insert rail 240 is configured as a rod with a circular cross-section. Those of skill in the art would appreciate that the insert rail could be configured with a cross-section such as a square, rectangle, triangle, rhombus, round with one or more flat sections, pentagon, hexagonal, I-shape, T-shape, L-shape, U-shape, etc. In other embodiments, the rail section 240 could be configured as an elongated tube.

In one or more embodiments, insert rail 240 further comprises a threaded hole 241 at its proximal end and threaded hole 242 at its distal end. In an exemplary configuration, cap 250 may be secured to insert rail 240 via threaded hole 242, using a bolt 301.

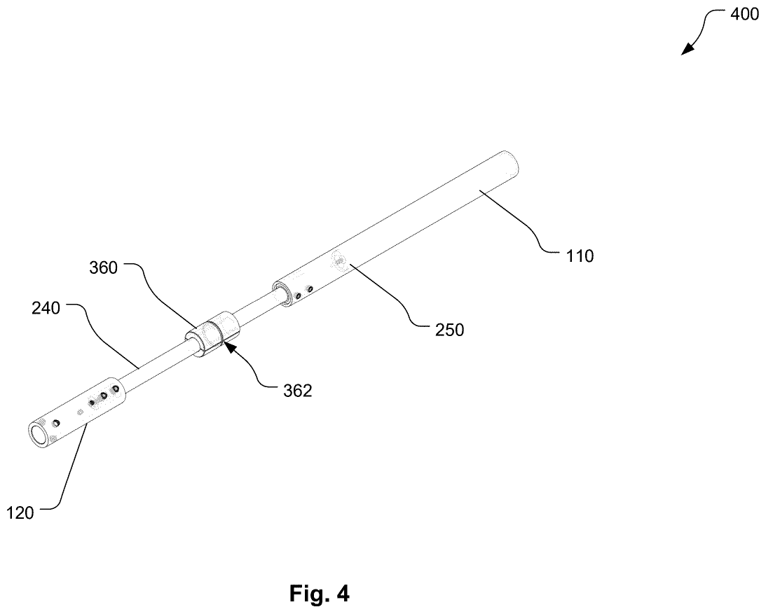

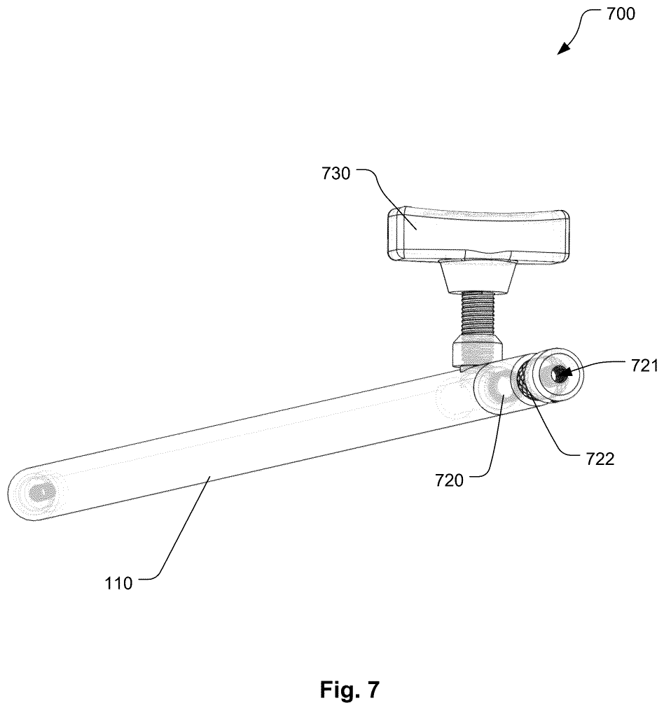

In one or more embodiments, the riser 120 further comprises one or more holes (or apertures) 122 for securing the riser to the insert rail 240 and one or more holes (or apertures), e.g. 124 and 125, for optionally securing an audio-visual device, e.g. pin, grip head, rigging clamp, etc. to the universal apparatus for rig construction in audio-visual applications. In one or more embodiments, holes 122 and 124 comprise threading configured to accept various threaded pins, rods, and locking screws. As illustrated in FIG. 4, one or more locking (or set) screws may be used to secure the riser 120 to the proximal end of insert rail 240 via threaded holes 122. Also, as illustrated in FIG. 7, one or more locking (or set) screws may be used to secure an A/V equipment, e.g. pins, grip heads and clamps for the specific application, to the proximal end of riser 120 via additional threaded holes, e.g. 124 and 125. Those of skill in the art would appreciate that the riser 120 could be configured with a cross-section such as a square, rectangle, triangle, rhombus, round, pentagon, hexagonal, etc.

FIG. 4 is an illustration of a closer view of the universal apparatus 400 for rig construction in audio-visual applications in a extended position, with the optional sleeve 360, and showing various orifices configured for locking bolts in accordance with one or more embodiment of the present invention. In this illustration, one or more locking bolts secures the distal end of the insert rail 240 via orifice 112 to the main tube 110; one or more locking screws couples the proximal end of the riser 120 to the distal end of the insert rail 240; and optional sleeve 360 is secured to insert rail 240, between riser 120 and main tube 110.

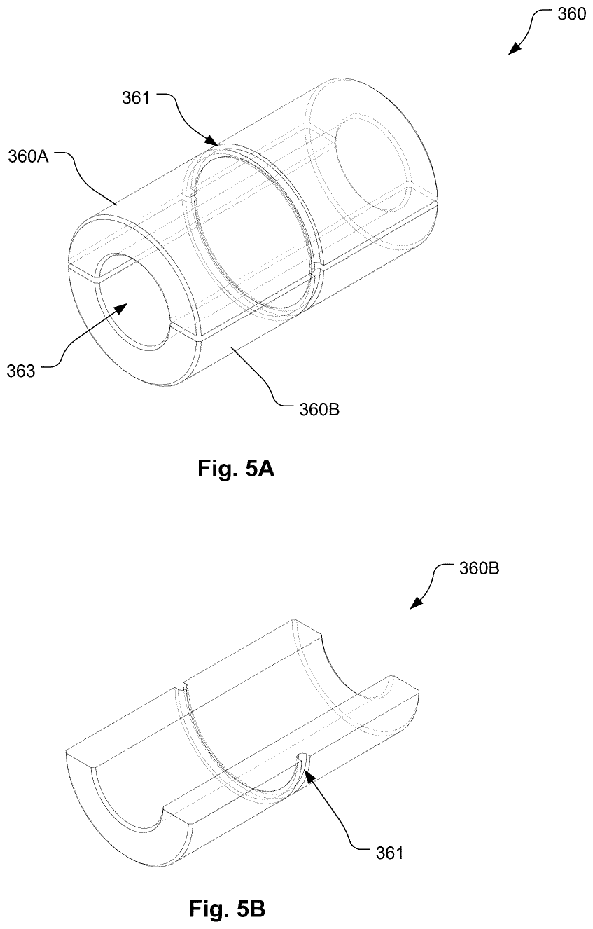

FIG. 5A is an illustration of the optional sleeve 360 of the universal apparatus for rig construction in audio-visual applications in accordance with one or more embodiment of the present invention. As illustrated, sleeve 360 is configured as a tube that is divided into two identical pieces comprising components 360A and 360B (illustrated in FIG. 5B). The sleeve 360 may optionally be secured to insert rail 240 via an elastic band or similar component, for example, via groove 361, which runs the outer perimeter of sleeve 360.

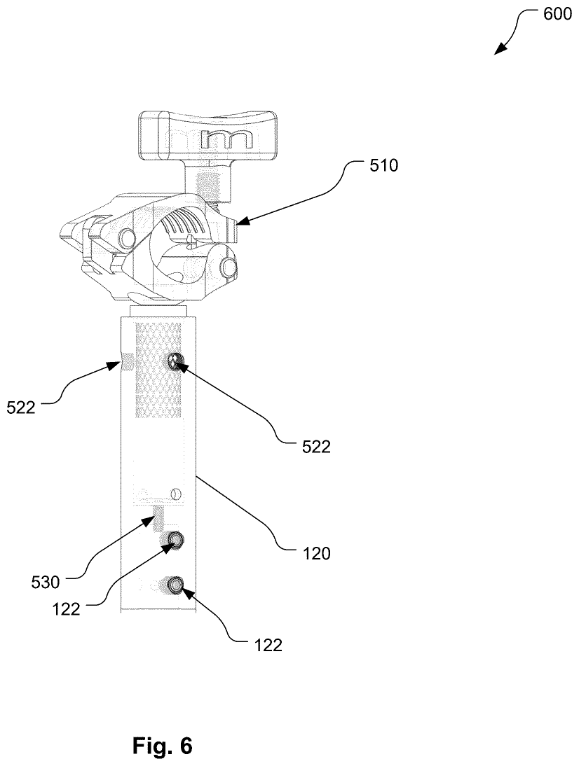

FIG. 6 is an illustration showing a rigging clamp 510 secured to the top of the universal apparatus 100 for rig construction in audio-visual applications in accordance with one or more embodiments of the present invention. As illustrated, the rigging clamp 510 may be coupled to the proximal end of the riser 120, using one or more locking screws 522 e.g. via orifice 124 and 125. An external device, e.g. a screw driver, may optionally be used to tighten (i.e. secure) or loosen (e.g. to remove) the rigging clamp on the riser 120.

In one or more embodiments, a bolt, e.g. 530, may be used to secure the rigging clamp to the insert rail, e.g. via threaded hole 241.

FIG. 7 is an illustration of the universal apparatus 700 for rig construction in audio-visual applications in the closed position and with a rig pin 720 attached thereon in accordance with one or more embodiment of the present invention. In this illustration, the riser is replaced with a baby pin adapter 720. The riser pin 720 includes the traditional serrated region 722 (to provide non-slip grip) and an orifice 721 at its proximal end for further coupling of additional A/V equipment.

Universal apparatus 700 further comprises a tightening knob (e.g. T-handle) 730 coupled to the main tube 110 for use in securing the insert rail 240 in a desired fixed position.

In one or more embodiments, the universal apparatus for rig construction comprises two or more main tubes 110 that is configured to telescope away from each other over one or more rails. In such configuration, each main tube be may be configured as described elsewhere in this specification. For instance, each main tube may be configured with one or more locking (or set) screws, one or more T-handles, etc.

While the invention herein disclosed has been described by means of specific embodiments and applications thereof, numerous modifications and variations could be made thereto by those skilled in the art without departing from the scope of the invention set forth in the claims.

1. A universal apparatus for rig construction comprising:
a main tube having a main tube orifice running a length of said main tube, wherein said main tube further comprises one or more securing holes at its proximal end;
a riser top having a riser top orifice running a length of said riser top, wherein said riser top further comprises one or more securing holes at its distal end; and
an insert rail configured to fit in said main tube orifice and further configured to be securable between a fully extended position and a fully retracted position in said main tube orifice using said one or more securing holes at the proximal end of said main tube, and wherein said insert rail is further configured to fit in said riser top orifice and to be securable to said riser top using said one or more securing holes at the distal end of said riser top.

2. The universal apparatus for rig construction of claim 1, further comprising a sleeve couplable around said insert rail in between said main tube and said riser top.

3. The universal apparatus for rig construction of claim 1, wherein said riser top is a baby pin adapter.

4. The universal apparatus for rig construction of claim 1, wherein a proximal end of said riser top is configured to be couplable to a rigging clamp.
